(19) United States
(12) Patent Application Publication
(10) Pub. No.: US 2026/0093570 A1
(43) Pub. Date: Apr. 2, 2026

(54) ADAPTIVE CASE HANDLING

(71) Applicant: International Business Machines Corporation, Armonk, NY (US)

(72) Inventors: Muhammad Jawad Paracha, Karachi (PK); Soumitra Sarkar, Cary, NC (US); Yu Deng, Yorktown Heights, NY (US); Aleksandra Hosa, Long Island City, NY (US); Ruchi Mahindru, Elmsford, NY (US)

(73) Assignee: International Business Machines Corporation, Armonk, NY (US)

(21) Appl. No.: 18/984,229

(22) Filed: Dec. 17, 2024

(30) Foreign Application Priority Data
Sep. 30, 2024 (PK) 6752024

(51) Int. Cl. G06F 11/07

(52) U.S. Cl. CPC G06F 11/0751

(57) ABSTRACT

An embodiment establishes a service request queue of unresolved service requests. The embodiment receives a new service request corresponding to a client. The embodiment computes a resolution time for the new service request. The embodiment computes a failure likelihood based at least in part on the resolution time computed for the new service request. The embodiment computes a subjective impact metric corresponding to the client based at least in part on the failure likelihood computed for the new service request. The embodiment updates the service request queue to include the new service request, wherein updating the service request queue comprises reprioritizing the set of unresolved service requests to insert the new service request within a particular location of a sequence of the unresolved service requests.

### BACKGROUND

The present invention relates generally to service request queue reprioritization. More particularly, the present invention relates to a method, system, and computer program for adaptive case handling within a resource constrained multi-system environment.

The triage problem traditionally refers to the challenge of determining how to prioritize medical attention to patients when resources are limited or medical attention is otherwise constrained. Today, the triage problem refers broadly to the challenge of prioritizing a set of tasks or items that needs attention in contexts or situations where resources are limited and not every task or item may be addressed simultaneously.

The concept of a triage problem today exists across various domains, including but not limited to, disaster management, project management, information technology, software development, as well various other domains where a set of tasks may exceed presently available resources necessary to accomplish the entire set of tasks simultaneously at the present moment. For example, in the context of information technology, a typical triage problem to solve may include handling service requests or incidents in IT support, where some issues need to be addressed before others to minimize overall, localized, and/or interdependent system impact.

Further, various industries exist where service is performed as part of a service agreement between a service provider and a client. Accordingly, the terms of a service agreement between a service provider and a client may define the expectations of the service provider to provide certain services to the client, as well as the conditions that result in a breach of the service agreement. Breach of a service agreement may result in a negative impact to customer satisfaction.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries. Accordingly, AI systems may be designed for various tasks that traditional computer systems were previously incapable, such as for example, deriving subjective insights from customer feedback, which may be utilized to make informed decisions and for improved customer satisfaction management.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex. An ANN today might have upwards of billions of interconnected “neuron” processor units, though may be trained using a far fewer number of dedicated hardware processor units (e.g., GPUs). Further, ANNs can be designed to uncover relationships between previously unknown factors.

### SUMMARY

The illustrative embodiments provide for adaptive case handling. An embodiment includes establishing a service request queue of unresolved service requests. The embodiment also includes receiving a new service request corresponding to a client. The embodiment also includes computing a resolution time for the new service request. The embodiment also includes computing a failure likelihood based at least in part on the resolution time computed for the new service request. The embodiment also includes computing a subjective impact metric corresponding to the client based at least in part on the failure likelihood computed for the new service request. The embodiment also includes updating the service request queue to include the new service request, wherein updating the service request queue includes reprioritizing the set of unresolved service requests to insert the new service request within a particular location of a sequence of the unresolved service requests. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example multi-system service environment in accordance with an illustrative embodiment;

FIG. 3 depicts a block diagram of an example process of adaptive case handling in accordance with an illustrative embodiment;

FIG. 4 depicts a block diagram of an example adaptive case handler software module in accordance with an illustrative embodiment;

FIG. 5 depicts a block diagram of an example system architecture in accordance with an illustrative embodiment;

FIG. 6 depicts a block diagram of a side-by-side comparison of example service request sequences in accordance with an illustrative embodiment;

FIG. 7 depicts a block diagram of an example training process for an adaptive case handler in accordance with an illustrative embodiment; and

FIG. 8 depicts a flowchart of an example process for adaptive case handling in accordance with an illustrative embodiment.

### DETAILED DESCRIPTION

Currently existing methods of solving a resource constrained multi-project scheduling problem typically rely on purely algorithmic approaches. However, existing technologies, and in particular purely algorithmic approaches, fail to consider impacts on subjective metrics as a byproduct result of output case handling. Accordingly, traditional algorithmic approaches are incapable of deriving subjective metrics, such as for example, potential impact of customer satisfaction, to incorporate into reprioritization of a pre-existing service request queue. The following disclosure addresses the deficiencies described above and includes a deep learning-based technique to address a resource constrained multi-project scheduling problem in a multi-system service environment.

Accordingly, the present disclosure addresses the deficiencies described above by providing a process (as well as a system, method, machine-readable medium, etc.) that develops an adaptive system for case handling that considers various parameters, including but not limited to, derived subjective metrics (e.g., impact to customer satisfaction) resultant from potential service-license agreement (SLA) breach, to reprioritize service requests in a dynamic multi-system networked computing environment. In some embodiments, the process leverages one or more machine learning techniques, such as for example to determine optimal service request reprioritization for achieving predefined context subjective goals.

In an embodiment, the system may include one or more deep learning mechanisms. At least one deep learning mechanism may be configured to reprioritize a task/service queue when a new case/request arrives. In an embodiment, one or more deep learning algorithms may be trained to learn patterns and relationships from historical data to make informed decisions on task reprioritization. In an embodiment, at least one deep learning mechanism may be configured, trained, fine-tuned, tailored, optimized, etc. to enable the system to consider subjective factors (e.g., customer satisfaction) in the adaptive case handling reprioritization process. In an embodiment, the system includes an optimization mechanism. The optimization mechanism may be configured to set the goals for the system, which may include, for example, minimizing service agreement violation penalties and/or minimizing customer dissatisfaction.

In an embodiment, the system includes a Resolution Time Prediction Model. The Resolution Time Prediction Model may be configured to compute an estimate for the time required to resolve a particular task or case. In an embodiment, the Resolution Time Prediction Model utilizes historical data, task complexity, and other relevant factors to estimate the time needed for resolution of a new task or case, accurately. In some embodiments, the system leverages one or more machine learning algorithms to provide reliable predictions for task resolution times.

In an embodiment, the Resolution Time Prediction Model may utilize Case Details for computing an estimated time for resolution of a service request. Examples of Case Details may include, but are not limited to, complexity of the issue, specific requirements, required components, potential challenges, etc.

In an embodiment, the Resolution Time Prediction Model may utilize Client Details for computing an estimated time for resolution of a service request. Example Client Details may include, but are not limited to, including historical response times, service level agreements, past interactions, etc. For example, a high-priority client with stringent SLA requirements may receive expedited service resulting in shorter resolution times. However, it is contemplated herein that in some cases, clients with stringent processes to permit access to their data center to enable service/repair may experience higher resolution times. Further, certain categories of problem types may typically take longer to resolve than others. In an embodiment, the ML prediction model learns to account for such differences.

Further, it is contemplated herein that a case for a high priority client with stringent SLAs in the service contract may not always result in a faster resolution of the case. Other factors, including for example, the complexity of the case, or the skill level of the service agent assigned to the case, may also have an impact on the resolution time for the case. Although a case for a client with a stringent SLA in the contract for the asset involved will typically be started sooner than cases for other clients or contracts with less rigorous SLAs, the ML model considers other factors for resolution time prediction, as discussed in greater detail herein. For example, the model may take into account the SLA of the contract associated with the case (i.e., SR features). In an embodiment, the resolution time prediction model predicts an amount of time required to resolve the problem that is the subject of the SR, regardless of when work on the SR is started.

In an embodiment, the Resolution Time Prediction Model may utilize historical data for computing an estimated time for resolution of a service request. Past performance data on similar service requests, including resolution times, bottlenecks, and outcomes, can be leveraged to predict the time needed for new requests. By analyzing historical data, the model can identify patterns and trends that impact resolution times of service requests. In an embodiment, the Resolution Time Prediction Model leverages past performance data on similar service requests, including resolution times, bottlenecks, and outcomes, to compute the estimated time required for resolution of a service request.

In an embodiment, the Resolution Time Prediction Model leverages availability of service providers, their skill levels, workload, and current commitments to compute the estimated time required for resolution of a service request. In an embodiment, the Resolution Time Prediction Model leverages information on the availability of resources, such as for example, hardware (parts to be replaced), software, equipment, tools, and personnel to compute the estimated time required for resolution of a service request. In an embodiment, the Resolution Time Prediction Model leverages information on one or more external variables, including but not limited to, weather conditions, traffic congestion, road closures, holidays, special events, unexpected events, catastrophes, etc. to compute the estimated time required for resolution of a service request.

In an embodiment, the Resolution Time Prediction Model leverages information about (or estimates thereof) of the skill level of the service support agent assigned to the case (the agent assignment is mandatory for the case to be entered in the unresolved cases queue). While privacy laws in different countries may prevent tool access to an agent's performance evaluations or even company-internal education history, information about resolution performance on past closed cases (SLA misses, inability to resolve the problem in one attempt, etc.) can be used as estimates of an agent's skill.

In an embodiment, the system includes a Resolution Time to Risk of Service License Agreement Breach Function (“Breach Function”). In an embodiment, the Breach Function defines a relationship between the predicted resolution time generated by the Resolution Time Prediction Model and the risk of breaching a service agreement—where the latter typically stipulates resolution time guarantees for service request of different severities in the IT support contract. Accordingly, by quantifying the risk associated with delays in task resolution, the Breach Function assesses the potential impact on service agreements caused by delay in task resolution, as well as may provide a mechanism to prioritize tasks based on their associated risks to prevent service agreement breaches and impact on customer satisfaction.

In an embodiment, the system includes a Triage Decision Support Model. The Triage Decision Support Model may be configured to receive inputs such as the risk of a service agreement breach from the Breach Function and Context Input. The Context Input may include at least one or more of various parameters, including but not limited to, case details (e.g., complexity, severity, resource requirements, etc.), client Net Promoter Score (NPS) for all cases across a period of time (e.g., week, month, year, etc.) history of breaches for the client in the most recent week with NPS, and other delayed service requests for the client currently. In an embodiment, the Triage Decision Support Model leverages risk of service agreement breach and resultant impact to customer satisfaction resultant from breach to make informed decisions regarding task prioritization and resource allocation. By considering the risk of breaching service agreements, client satisfaction levels, and other contextual factors, the model assists in determining the optimal sequence of tasks (or cases)—not yet closed—to minimize the likelihood of service agreement breaches and customer dissatisfaction. In an embodiment, the model modifies a sequence of service requests stored in memory to physically alter the stored sequence of services requested recorded in memory.

In an embodiment the reprioritization process considers client context for both the queued service requests (SRs) and the new SR to provide a comprehensive approach to decision-making by incorporating subjective impact metrics not only for the new SR but also for the queued SRs being reprioritized. By including client context information for all SRs in the queue, the model can assess the potential impact of reprioritization on client satisfaction metrics such as Net Promoter Score (NPS) or Customer Satisfaction (CSAT) for both the new and existing SRs.

In this embodiment, the model evaluates the subjective impact metrics of the new SR in conjunction with the subjective impact metrics of the queued SRs that may be affected by the reprioritization process. By considering the client context for all SRs involved, including factors like contract status, historical interactions, and NPS scores, the model can make informed decisions that balance the needs and expectations of all clients involved. This holistic approach ensures that the reprioritization process is not only optimized to prevent SLA breaches but also to enhance overall client satisfaction across the board. By factoring in the subjective impact metrics of both the new SR and the queued SRs, the model can prioritize service requests in a way that maximizes client satisfaction and loyalty across all clients serviced by the IT support provider and not just the client associated with the new service request, while maintaining operational efficiency. This embodiment highlights the importance of considering the broader client context and impact metrics in decision-making processes, enabling the model to deliver personalized and client-centric solutions that drive positive outcomes for all stakeholders involved.

The illustrative embodiments provide for adaptive case handling in a resource constrained multi-system environment. As used throughout the present disclosure, the term “case handling” refers to the process of managing, tracking, and resolving a “case” or “service request” from its initiation to its closure. Case handling may include assigning a case to appropriate resources, monitoring progress, updating stakeholders, and ensuring that the issue or request is resolved according to defined service levels and/or priorities.

As used throughout the present disclosure, the term “case” refers to a specific instance of an issue, problem, or task that requires attention, investigation, or some form or action. A case may include a customer issue, incident, or request that may need to be managed and/or resolved by an appropriate service request specialist/respondent.

As used throughout the present disclosure, the term “service request” refers to a formal request for service or assistance, such as for example, from a client, customer or user, that may require action from a service provider. A service request may include a request for information, advice, access to service, resolving an issue, initiating an update, repairing a failed hardware or software asset, and so forth. Unless otherwise explicitly stated or indicated by the context, the terms “case” and “service request” are hereby understood to be synonyms and may be used interchangeably for the purpose of the present disclosure.

As used throughout the present disclosure, the term “queue reprioritization” refers to the process of reordering cases or service requests in a queue based on certain parameters, such as for example, severity, urgency, impact, priority level, etc. Some embodiments of the present disclosure leverage one or more deep learning techniques to assist performing queue reprioritization to accomplish adaptive case handling in resource constrained multi-system environment. As used throughout the present disclosure, the term “service request queue” refers to a data structure that captures a particular (ordered) sequence of unresolved service requests.

As used throughout the present disclosure, the term “resource constrained multi-system environment” (“RCMSE”) refers to a technical or operational setting where multiple interconnected systems or platforms may operate with limited resources, such as for example, computing power, memory, bandwidth, personnel, human resources, time, etc. In an RCMSE, available resources at a present moment in time may be insufficient to meet all demands, cases, and/or service requests, simultaneously, thereby requiring selective management, prioritization, and/or allocation of available resources to ensure effective operation of system processes as well as ensure that predefined service levels are met, or in the event that service levels cannot be met, minimize the impact of a breach of service level agreement on customer satisfaction.

As used throughout the present disclosure, the term “Net Promoter Score” (or simply “NPS”) refers to a measure of customer satisfaction. Accordingly, NPS is a market research metric that is typically obtained via one or more survey questions asking respondents to rate the likelihood that they would recommend a company, product, or a service to another person. For example, an NPS survey question may be similar to the following: “On a scale from 0 to 10, how likely are you to recommend this product/company to a friend or colleague?” Although the terms “Net Promoter Score” and “NPS” are used for the sake of clarity and simplicity, it is to be understood that the terms “Net Promoter Score” and “NPS” may refer to any measure of customer satisfaction (“CSAT”).

Illustrative embodiments include establishing a service request queue. In an embodiment, the service request queue includes a set of unresolved service requests.

Illustrative embodiments include receiving a new service request corresponding to a client. Illustrative embodiments include computing a resolution time for the new service request. Illustrative embodiments include computing a failure likelihood based at least in part on the resolution time computed for the new service request.

Illustrative embodiments include computing a subjective impact metric corresponding to the client based at least in part on the failure likelihood computed for the new service request. Illustrative embodiments include updating the service request queue to include the new service request, wherein updating the service request queue comprises reprioritizing the set of unresolved service requests to insert the new service request within a particular location of a sequence of the unresolved service requests.

In some embodiments, the subjective impact metric comprises customer satisfaction. In some embodiments, the subjective impact metric is derived from historical client feedback data. Some embodiments further include training a neural network to uncover a relationship between service request resolution failure and impact on customer satisfaction.

In some embodiments, updating the service request queue includes delaying a start time for the new input service request. In some embodiments, updating the service request queue includes delaying a start time for at least one other unresolved service request of the service request queue in order to prioritize the start of the new input service request. In some embodiments, updating the service request queue includes pausing at least one unresolved service request of the service request queue.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

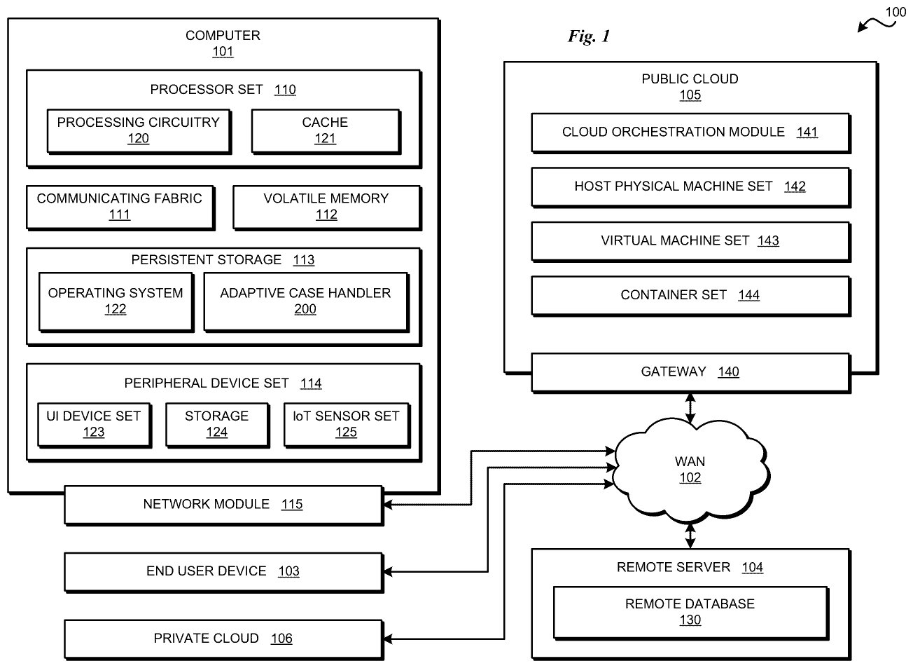

With reference to FIG. 1, this figure depicts a block diagram of a computing environment 100. Computing environment 100 contains an example of an environment for the execution of at least some of the computer code involved in performing the inventive methods, such as an adaptive case handler 200 may be configured to automatically reprioritize a service request queue of a resource constrained multi-system environment based on various derived metrics. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

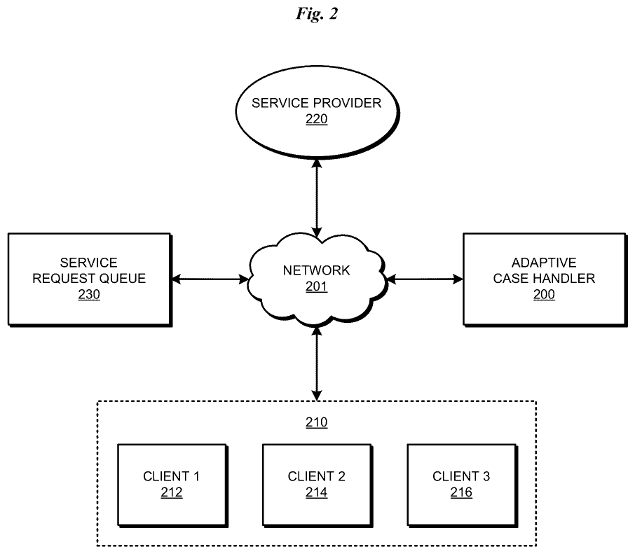

With reference to FIG. 2, this figure depicts a block diagram of an example multi-system service environment in accordance with an illustrative embodiment. In the illustrated embodiment, the multi-system service environment includes the adaptive case handler 200 of FIG. 1.

In the illustrated embodiment, the adaptive case handler 200 receives service requests from a set of client 210 via a network 201 and in response generates and provides an updated prioritized service request queue to service provider 220 each time a new service request is received. The adaptive case handler 200 evaluates the new service request to compute the estimated resolution time for the service request, a risk of breaching an agreement based on the computed resolution time estimate, and an impact on a subjective client metric resultant from a potential breach of the agreement. Embodiments of the multi-system service environment include one or more of a variety of different types of service environments having varying degrees of complexity. Embodiments disclosed herein described the service environment within the context of physical IT hardware locations; however, this is for descriptive purposes only and is not intended to be limiting, and the service environment may include elements of any type of service environment, including any physical environment, virtual environment, or any combination thereof.

In the illustrated embodiment, the multi-system environment of FIG. 2 may include a resource constrained multi-system environment that includes a set of clients 210, including a first client 212, a second client 214, and a third client 216. Suppose a scenario where one or more the set of clients initiates a service request to be handled and/or resolved by service provider 220. Further, in such a scenario, the order of which service requests are attenuated to and completed may be determined by the service request queue 230 which maintains a sequence of unresolved service requests. In some embodiments, the order of service requests to be attended to and/or resolved may be based at least in part by the severity of each request, available resources, and/or impact to other metrics, such as for example, impact to customer satisfaction as a result of failing to fulfill a service request in accordance with a service level agreement (SLA).

In the illustrated embodiment, the adaptive case handler 200 is configured to reprioritize service request queue 230 based on one or more parameters, metrics, and/or optimization criteria. In an embodiment, the adaptive case handler 200 includes a processor, a memory, and a set of instructions stored on the memory that when executed by the processor cause the adaptive case handler 200 to perform the following example operations. In an embodiment, the adaptive case handler 200 establishes a service request queue of unresolved service requests. In an embodiment, the adaptive case handler 200 receives a new service request corresponding to a client. In an embodiment, the adaptive case handler 200 computes a resolution time for the new service request. In an embodiment, the adaptive case handler 200 computes a failure likelihood based at least in part on the resolution time computed for the new service request. In an embodiment, the adaptive case handler 200 computes a subjective impact metric corresponding to the client based at least in part on the failure likelihood computed for the new service request. In an embodiment, the adaptive case handler 200 embodiment updates the service request queue to include the new service request, wherein updating the service request queue comprises reprioritizing the set of unresolved service requests to insert the new service request within a particular location of a sequence of the unresolved service requests.

In some embodiments, the adaptive case handler 200 comprises a physical computing device, including but not limited to, a personal computer, a laptop, a smartphone, a tablet, etc. In some embodiments, the adaptive case handler 200 comprises specialized hardware, such as for example, a Application-Specific Integrated Circuit (ASIC) or Field-Programmable Gate Array (FPGA) for accelerated processing of specific tasks, routines, algorithms, training operations, etc. In some embodiments, the adaptive case handler may include a combination of physical and virtualized components, as well as may be partially or entirely virtualized on a virtual machine.

As described herein, the adaptive case handler 200 may provide an intelligent service request resolution recommendation system that manifests in the form of an Internet website or a mobile application that is accessible by a user device of service provider 220. A backend administration system allows users with administrative privileges to perform various administrative tasks associated with the adaptive case handler 200 as described herein, such as initiating a data collection and/or correlation process, a neural network training process, defining optimization goals, defining execution parameters/criteria, defining subjective metrics, and any other defined settings discussed herein.

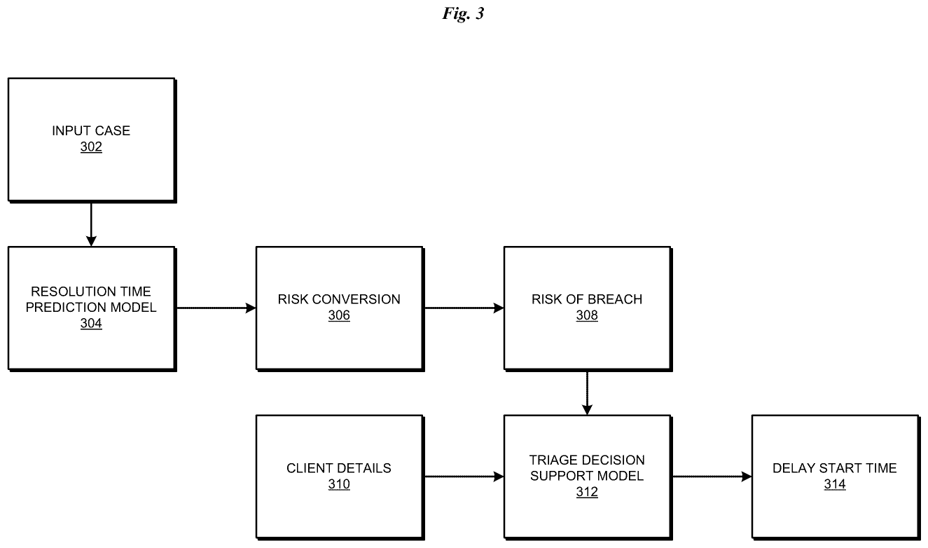

In some embodiments, service request queue 230 maintains information about the status of each instance of a case or service request including performance information associated each of the service instances. In some embodiments, adaptive case handler 200 connects with API gateway via any suitable network 201 or combination of networks such as the Internet, etc. and uses any suitable communication protocols such as Wi-Fi, Bluetooth, etc. to connect to service request queue 230 and/or service provider 220. The API gateway may transmit service requests received from the set of clients 210 to adaptive case handler 200 With reference to FIG. 3, this figure depicts a block diagram of an example system for adaptive case handling in accordance with an illustrative embodiment. In an embodiment, the adaptive case handler 200 of FIGS. 1 and 2 may be configured and/or to perform the following example operations.

In the illustrated embodiment, the resolution time prediction model 304 receives a new input case 302. Further, based on the predicted resolution time for the new input case 302, a risk conversion 306 is performed to covert the resolution time into a risk of breach 308. Further, in the illustrated embodiment, a combination of the risk of breach 308, and client details 310 are input into a triage decision support model 312 to output a delay start time 314 for either the new input case 302 or any other existing service request in a service request queue. In some cases, the output delay start time may be 0, indicating no delay to start time. In some embodiments, the output of the triage decision support model 312 includes pausing at least one in-progress unresolved service request of an unresolved service request queue.

In the illustrated embodiment, the triage decision support model 312 leverages Client Details 310 and risk of SLA Breach 308 to determine a potential impact on customer satisfaction. Client Details, including historical data, preferences, and feedback, provide insights into the client's expectations and satisfaction levels. Accordingly, by analyzing Client Details, the model can assess the client's relationship with the service provider, past experiences, and specific requirements to prioritize service requests based on their potential impact on customer satisfaction. This proactive approach mitigates risks of dissatisfaction, and optimizes resource allocation to enhance overall service quality and client relationships. In an embodiment, Client Details 310 is representative of all clients across all unresolved service requests within an unresolved service request queue. In an embodiment, the Triage Decision Support Model 312 inputs risk of SLA Breach 308, the existing unresolved Service Request Queue 316, and Client Details 310 to output a Delay Start Time 314 that maximizes customer satisfaction for all clients represents by Service Request Queue 316. Accordingly, the Triage Decision Support 312 model is able to consider holistically the impact of reprioritizing the SRs queue in order to start the new SR at an optimal start time.

In some embodiments, Client Details can be utilized to prioritize service request start times based on various factors, including for example, the status of the client's contract. For instance, a client whose contract is nearing its end may be considered less critical in terms of service prioritization compared to a client whose contract has just begun. By analyzing the contract status of clients, the system can make informed decisions on when to start servicing their requests. Accordingly, clients with contracts that are about to end may be deprioritized in favor of clients with newly initiated contracts to ensure a positive initial experience and foster long-term relationships. By giving priority to clients at the beginning of their contract period, the service provider can establish a strong foundation for future engagements and potentially secure contract renewals.

In some cases, a client whose contract is nearing its end may be considered more critical in terms of service prioritization compared to a client whose contract has just begun. For example, if contract is new and the service provider is insufficient in the handling of a new service request, then there may still be many other opportunities in the lifetime of a contract to improve performance, so that the previous bad performance may be less impactful on overall customer satisfaction in light of a forward history of positive service request performance. On the other hand, if a contract is nearing its end, then contract renewal discussions may soon begin or may already be in progress, and during that small window, there may not be enough time to rectify the handling of service requests, which ultimately may cause the recent bad performance to have greater impact on consideration of potential contract renewal than compared to a case where the bad performance was experienced at the beginning of a term of a contract.

By adaptively managing the start times of service requests based on contract status, the system can allocate resources efficiently to maximize customer satisfaction, or any other desired derived subjective metric. Accordingly, it is contemplated herein that a client-centric subjective approach for service request resolution prioritization optimizes resource utilization for improved overall service requests resolution performance.

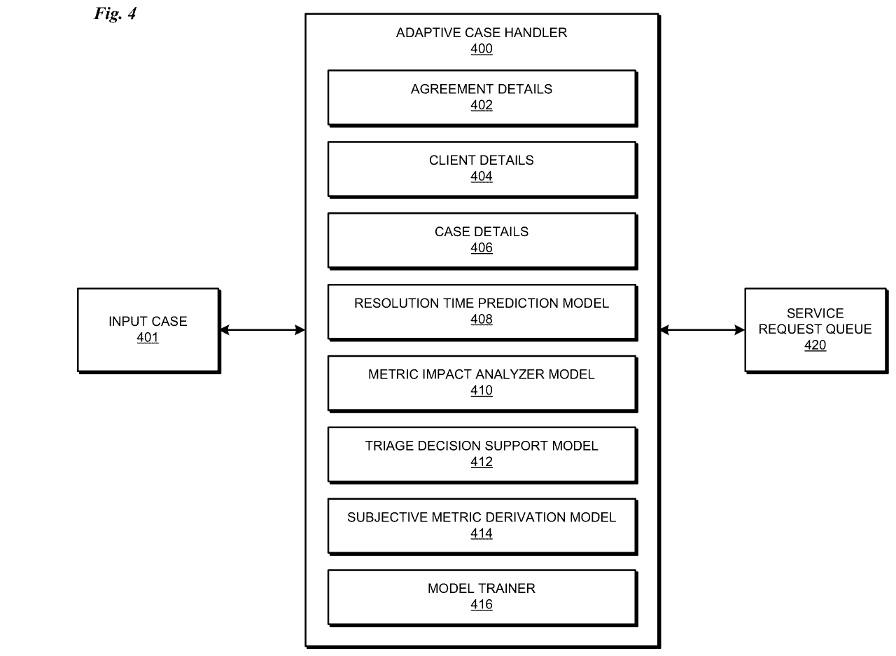

With reference to FIG. 4, this figure depicts a block diagram of an example adaptive case handler module 400 in accordance with an illustrative embodiment. In the illustrated embodiment, the adaptive case handler 400 may include adaptive case handler 200 of FIG. 1 and/or adaptive case handler 200 of FIG. 2.

In the illustrated embodiment, the adaptive case handler module 400 may include an Agreement Details module 402, a Client Details module 404, a Case Details module 406, a Resolution Time Prediction Model 408, a Metric Impact Analyzer Model 410, a Triage Decision Support Model 412, a Subjective Metric Derivation Model 414, and a Model Trainer module 416.

In an embodiment, the Agreement Details module 402 is a software module configured to store and manage information related to service-level agreements (SLAs) and contractual obligations between the service provider and clients. In an embodiment, the Agreement Details module 402 establishes and maintains a database of SLA terms, conditions, and performance metrics to ensure compliance and track adherence to agreed-upon standards. In an embodiment, the Agreement Details module 402 interfaces with other modules to retrieve relevant agreement details.

In an embodiment, the Client Details module 404 is a software module configured to store and organize client-specific information, including client profiles, preferences, historical data, and feedback. In an embodiment, Client Details module 404 establishes and maintains a database for client-related data, enabling computation of subjective metrics, including but not limited to, historical impact on client satisfaction caused by SLA breach.

In an embodiment, the Case Details module 406 is a software module configured to receive, store, and/or manage information pertaining to individual service requests or cases. Case Details module 404 records Case Details, including but not limited to, case descriptions, severity levels, task complexities, and other relevant details to facilitate efficient case handling. Case Details module 404 interacts with other modules of adaptive case handler 400 to provide comprehensive case information for analysis, prediction, and decision support.

In an embodiment, the Resolution Time Prediction Model 408 is a software module configured to compute an estimated time for completion of a service request, i.e., from the time that work on it has started until it is completely resolved. In an embodiment, if a SR remains in the unresolved SRs queue for a period of time until work on it can be started, then the wait time is not considered to be part of the overall resolution time. In an embodiment, the Resolution Time Prediction Model 408 leverages historical data, task attributes, and contextual factors to predict the time required to resolve a case.

In an embodiment, the Metric Impact Analyzer Model 410 is a software module configured to analyze the impact of SLA breaches on customer satisfaction and other subjective metrics. The Metric Impact Analyzer Model 410 module evaluates historical data to quantify the repercussions of SLA violations on client relationships and satisfaction levels. In an embodiment, the Metric Impact Analyzer Model 410 communicates with other modules to assess the consequences of potential breaches and prioritize tasks accordingly.

In an embodiment, the Triage Decision Support Model 412 is a software module that integrates SLA compliance, customer satisfaction, and resource availability to prioritize service requests effectively. This module leverages real-time data and historical performance metrics to make informed decisions on task sequencing and resource allocation. It collaborates with other modules to optimize task prioritization and enhance service delivery.

In an embodiment, the Subjective Metric Derivation Model 414 is a software module configured to compute a subjective metric. In an embodiment, customer satisfaction may be computed based on survey data collected from clients that include feedback questionnaires related to SLA breaches. Additional sources of customer satisfaction data and/or customer expectation data may be collected from customer interaction logs, social media, customer reviews and ratings, Net Promoter Score (NPS), and/or customer behavior analysis. Accordingly, by leveraging a combination of survey data and/or other sources of information, the Subjective Metric Derivation Model 414 can compute customer satisfaction comprehensively, considering diverse sources of feedback and to provide a holistic insights into customer sentiment and expectations.

In an embodiment, the Model Trainer module 416 is a software module configured to establish, train, and/or and update machine learning models used within the adaptive case handler system. The Model Trainer module 416 processes historical data, fine-tunes algorithms and/or model parameters, and optimizes model performance based on predefined goals and/or criteria, as discussed in greater detail herein.

In an embodiment, the Model Trainer module 416 is configured to train one or more machine learning models, such as for example, neural networks, decision trees, support vector machines, and ensemble methods. In an embodiment, the Model Trainer module 416 provides functionalities for data preprocessing, feature engineering, model selection, hyperparameter tuning, and performance evaluation.

In an embodiment, the Model Trainer module 416 is configured to initiate a model training process for the Service Resolution Time Model. In an embodiment, the training process begins with unsupervised clustering to identify problem categories in service requests prior to supervised (regression) model training. Accordingly, this step may include identifying categories of service requests based on problem descriptions. In an embodiment, a case-similarity model may be employed to improve category identification. In an embodiment, this step includes determining a similarity measure to use to cluster tickets into categories. In some embodiments, one or more clustering algorithms, such as for example, K-Means clustering, or other aspects of any suitable algorithms can be employed.

In an embodiment, for each identified category, a resolution time prediction model is trained specifically for that category of problem. It is contemplated that this approach enables for the model to be tailored to the unique characteristics and patterns of each category, thereby optimizing the accuracy and effectiveness of the resolution time predictions. Accordingly, by training separate models for different categories of service requests, the Adaptive Case Handler can provide more precise and reliable estimates of resolution times, enhancing its ability to prioritize and manage service requests efficiently.

Further, illustrative embodiments include selecting one or more appropriate neural network architectures for resolution time prediction. In an embodiment, the model architecture includes a feedforward neural network, where input features such as problem description, client details, and historical data are fed into the network for training. The network may include multiple layers of neurons, with each layer processing the input data to learn the underlying patterns and relationships that influence resolution times. In an embodiment, a recurrent neural network (RNN), a Long Short-Term Memory (LSTM) model, and/or a Transformer model, can be utilized to capture sequential dependencies in the input data—such as the queue of unresolved service requests (each associated with a risk, other SR characteristics, or client context information)—which exists when a new SR is created and its start time needs to be predicted for most optimal scheduling and handling. Further, in addition to or in place of certain neural network architectures, alternative machine learning models, such as for example, support vector machines (SVMs) may also be considered for training the resolution time prediction model.

In an embodiment, the Resolution Time Prediction Model for an SR includes a regression model trained to predict a time required to resolve a case. In an embodiment, the Triage Decision Support Model includes a deep learning sequence model, a regression model which takes the output of the deep learning sequence model (RNN, LSTM, Transformer) and the features of the new SR, and the associated Client Context, to predict the start time of the new SR.

In an embodiment, the Model Trainer module 416 is configured to initiate a training process for a regression model, as described in greater detail herein. In a particular embodiment, the training process for the regression model follows the unsupervised clustering step previously mentioned. In an embodiment, the supervised (regression) model training phase may include training one prediction model per service request (SR) category. Each historical service request may be assigned to a specific category based on the clusters identified in Step 1. The SR details, including the SR category, service request respondent skill level, and location-specific details, are then used as features for training the category-specific model. By tailoring the model to each SR category and incorporating relevant features, the regression model can provide accurate and customized predictions for resolution times.

In an embodiment, the features used in the regression model training include may include the SR category, which differentiate between different types of service requests and their associated resolution time patterns. Additionally, the service request respondent skill level is considered as a feature, reflecting the expertise and capabilities of the personnel assigned to handle the service request. Location-specific details are also included as features, taking into account geographical factors that may influence service request resolution times. In an embodiment, training includes developing catch scenarios related to the assumption made during the regression model training that the required service request personnel and parts are available for the immediate start of service request resolution. Accordingly, these catch scenarios and assumptions mitigate potential biases introduced by external factors such as missing parts, unexpected delays, power outages, or other unforeseen circumstances. By ensuring that the model is trained under the assumption of optimal conditions for service request resolution, the Adaptive Case Handler computes accurate intrinsic relationships between the input features and resolution times.

In an embodiment, the Model Trainer module 416 is configured to initiate a training process for a Start Time (Delay) Predictor Model for computing a start time delay for a newly received service request. In an embodiment, the process includes establishing a sequence model for training the Start Time (Delay) Predictor Model. In an embodiment, the model may include one or more aspects of a Long Short-Term Memory (LSTM), Transformer, or other sequence models to handle varying length sequences of current unresolved service requests (SRs). In an embodiment, each SR is represented as a feature vector, and these feature vectors are fed into the sequence model, the output of which is fed into a Regression model to predict the start time delay for the new service request. In an embodiment, the output of the sequence model includes a representation of the sequence of unresolved SRs. Further, in an embodiment, this sequence representation of the SRs queue is fed into the Regression model, combined with the features of the new, ‘to be triaged’ SR which are also fed into the Regression model, which causes the Regression model to predict the new SR start time.

In an embodiment, the training of the Start Time (Delay) Predictor Model may be performed per territory, where a territory represents a group of service request respondents serving a pool of customers. To account for the diverse needs and characteristics of different industries, a separate model may be established and/or trained for each industry sector. Additionally, meta-learning and/or transfer learning techniques may be employed to train a model for a particular client, and then may be adapted for other similar clients. Accordingly, it is contemplated herein that this approach enhances the model's ability to generalize across different customer segments and territories, improving its predictive accuracy and efficiency.

In an embodiment, the training data generation process for the sequence model includes analyzing historical service request data to identify instances where the Service Level Agreement (SLA) was missed. For each SR that missed the SLA and resulted in a dissatisfied customer Net Promoter Score (NPS), the start time for that SR is adjusted to ensure SLA compliance. This adjustment may cause other SRs that previously met the SLA to miss it. In such cases, only the specific SR causing the violation is abandoned, and training data generation continues with the remaining SRs. Training instances are created based on scenarios where no existing compliant SR turns non-compliant after adjusting the start time of an SR which did miss the SLA to ensure no violation. Each such scenario provides one training instance for the Triage Decision Support model. This process provides critical data for model training and optimization. By leveraging sequence models, territory-specific training, industry sector segmentation, and customer response analysis, the Start Time (Delay) Predictor Model in the Adaptive Case Handler can effectively predict start time delays for service requests, optimize SLA compliance, and enhance customer satisfaction across diverse customer segments and territories.

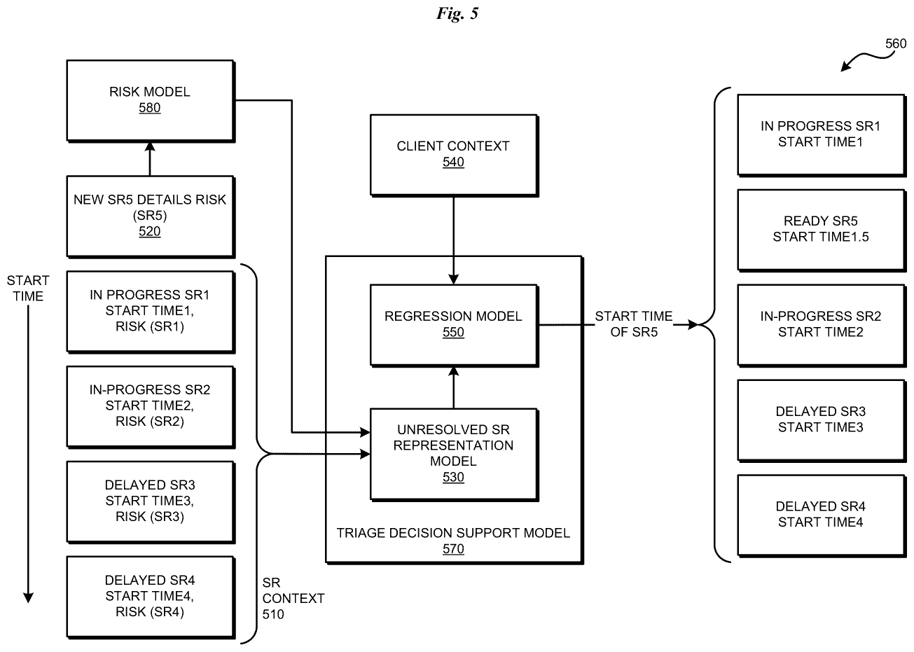

With reference to FIG. 5, this figure depicts a block diagram of an example system architecture related to service request queue reprioritization, in accordance with an illustrative embodiment. In the illustrated embodiment, a service request queue 510 comprises a combination of in-progress and delayed unresolved service requests. A new service request 520 transmitted from a client is input into risk model 580 that computes a risk of SLA breach..

In the illustrated embodiment, the Triage Decision Support Model 570 includes a service request representation model 530, which includes a trained sequence model trained to capture-for each new SR creation scenario where it is invoked, to determine the start of a new case-a compact representation (e.g., single vector or real numbers) of all queued unresolved cases which exist at that moment. Accordingly, the service request representation model 530 outputs a digital representation of the unresolved SR queue 510. Further, in the illustrated embodiment, the Triage Decision Support Model 570 includes a regression model 550 trained to predict the optimal start time of the new SR which will minimize the potential to miss SLAs for the new SR while not worsening the chances of missing SLA for the already queued SRs. In the illustrated embodiment, the output of the risk model 580 combined with the vector representation output by the SR representation model 530 are fed into the regression model to predict a start time for the new service request 520 (SR5).

In the illustrated embodiment, the service request representation model 530 includes a deep learning sequence model that transforms a service request queue into a vector sequence representation that is then input into a trained regression model to determine an optimal sequence that avoids any missed Service Level Agreements (SLAs). The vector sequence representation generated by the deep learning sequence model captures the essential information from the service request queue, including but not limited to, the order of SRs, their features, and the client context for each SR.

In the illustrated embodiment, the regression model 550 is trained to predict an optimal sequence that minimizes the likelihood of missed SLAs. By considering the historical data and training instances where rearranging the SR queue led to successful outcomes without breaching SLAs, the regression model 550 can make informed decisions based on the vector sequence representation provided by the service request representation model 530. Accordingly, the trained regression model may be enabled to determine an optimal sequence of service requests that maximizes client satisfaction and operational efficiency while simultaneously avoiding any missed SLAs. By transforming the complex and dynamic SR queue into a vector sequence representation and leveraging the predictive capabilities of the regression model 550, the Triage Decision Support Model 570 is enabled to provide data-driven decisions in real-time triage scenarios. Further, the Triage Decision Support Model 570 may be trained to adapt to varying client contexts, prioritize service requests effectively, and proactively mitigate the risk of SLA breaches.

In an embodiment, the case handler triage support model 570 includes a component that determines the delay for a newly received service request. When a new service request, such as SR5, is received, the model assesses whether it can be delayed based on certain criteria. If SR5 can be delayed, it is placed in the queue with a designated start time. If not, a service request respondent is assigned to address it. In cases where no respondent is available, a respondent working on an existing service request may be reassigned to SR5 to ensure timely resolution. This reassignment process also accounts for situations where a respondent is already engaged in handling an IN-PROGRESS service request, necessitating their removal from that case and reassignment to SR5. Accordingly, an embodiment may includes pausing at least one unresolved service request of the service request queue.

For example, suppose the following scenario depicted: A service request queue includes a set of unresolved service requests: SR1, SR2. SR3, and SR4. Further, suppose a new service request SR5 is received. In such an example scenario, the model may determine if SR5 can be delayed. If so, SR5 may be placed in the queue based on start time 5. If not, a service request respondent may be assigned to it immediately. In a scenario where no service request respondent is available, a service request respondent assigned to an existing service request may be reassigned to SR5. Further, this covers the case where a service request respondent is already working on an IN-PROGRESS service request and so that service request respondent is removed from that case and reassigned to SR5. Accordingly, an IN-PROGRESS service request may be comprising paused so that a service request respondent may be assigned to a more urgent service request than the previously assigned service request to that service agent.

Further, in the context of the Adaptive Case Handler, the unresolved Service Request Queue is represented as a sequence of vectors that encapsulate the Service Request, its predicted risk, and its own Client Context information. A Client Context comprises various features that may include, but are not limited to, the latest weekly Net Promoter Score (NPS) for the client associated with a given SR, including historical data on customer service requests with missed SLAs over a week, and the time remaining until the customer contract expires. When a new service request, such as SR5, is introduced, it includes detailed information about the case, its client context, and contract agreement specifics. The risk of breaching the Service Level Agreement (SLA) for any SR-is determined by analyzing the case details, client information, etc., based on the Resolution Time Prediction model and the Risk determination module. This comprehensive assessment enables the system to prioritize and manage service requests effectively based on their urgency and potential impact on SLA compliance and customer satisfaction.

In an embodiment, the unresolved SRs queue includes Client Context details for each SR in the queue. Accordingly, the sequence of queued SRs (including the Client Context of each SR) is fed to the sequence model. In an embodiment, the Client Context of SR5 is not fed to the sequence model, and is only fed into the Regression model, since SR5 is not part of the sequence of unresolved SRs but is considered separately as the new SR.

In an embodiment, the prioritization of SR5 in the historical service request data is utilized to generate training instances for the Triage Decision Support model 570. For example, suppose a scenario where SLA was missed for SR5 and the weekend customer NPS was low, the Ready SR5 reprioritization process is initiated, which may include computing the desired prioritization using SR history data and identifying the minimum priority adjustment that would have prevented the SLA breach for SR5. If this reprioritization using historical SR data is successful, then this constitutes a valuable training instance which can be used to train the Triage Decision Support Model. In an embodiment, to ensure that model training instances generated using this process results in a model trained to provide optimal decision-making when deployed, the system evaluates the potential impact on customer NPS if adjusting the priority for SR5 results in another service request, such as SR4, missing its SLA. This enables the trained Adaptive Case Handler to make informed decisions that balance SLA compliance with customer satisfaction levels effectively.

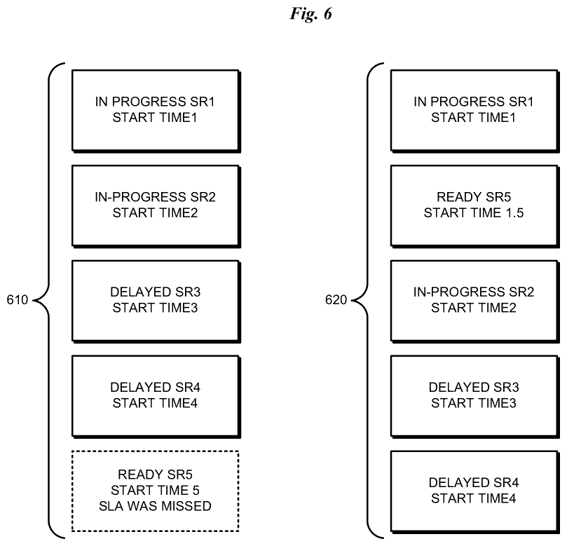

With reference to FIG. 6, this figure depicts a block diagram of side-by-side comparison of example service request queues, in accordance with an illustrative embodiment. In the illustrated embodiment, a first service request queue 610 comprising a first sequence of service requests, and a second service request queue 620 comprising a second sequence of service requests, is shown. In the example embodiment, each sequence of service requests is ordered according to start time of service requests. As depicted in the example embodiment, the first sequence of service requests includes a ready to resolve service request (SR5)-the new received service request—still unresolved, causing SLA condition to be breached. In comparison to the first sequence of service requests, the second sequence of service requests includes the ready to resolve service request (SR5) positioned at start time 2.5, and no SLA breaches resulted as a delay of start time to and/or pausing of one of the other unresolved service requests. Accordingly, by leveraging a combination of Case Details, SLA details, and/or Client Details, the adaptive case handler system described herein provides a holistic approach to solving a resource constrained multi-project scheduling problem.

With continued reference to FIG. 6, each of the first service request queue 610 and the second service request queue 620 may be utilized for generating training instances for training the Triage Decision Support model. In an embodiment, training the Triage Decision Support Model involves utilizing simulated predicted sequences that result in no SLA breach. These sequences are derived from historical data where the rearrangement of the SRs queue prevented any breach of service level agreements. By being trained on these instances, the model can learn from successful scenarios and optimize its decision-making process to minimize the risk of SLA breaches in real-time triage situations. The training instances based on these simulated predicted sequences serve as critical training data that is useful for the model to understand the optimal sequencing of service requests to maintain client satisfaction and operational efficiency.

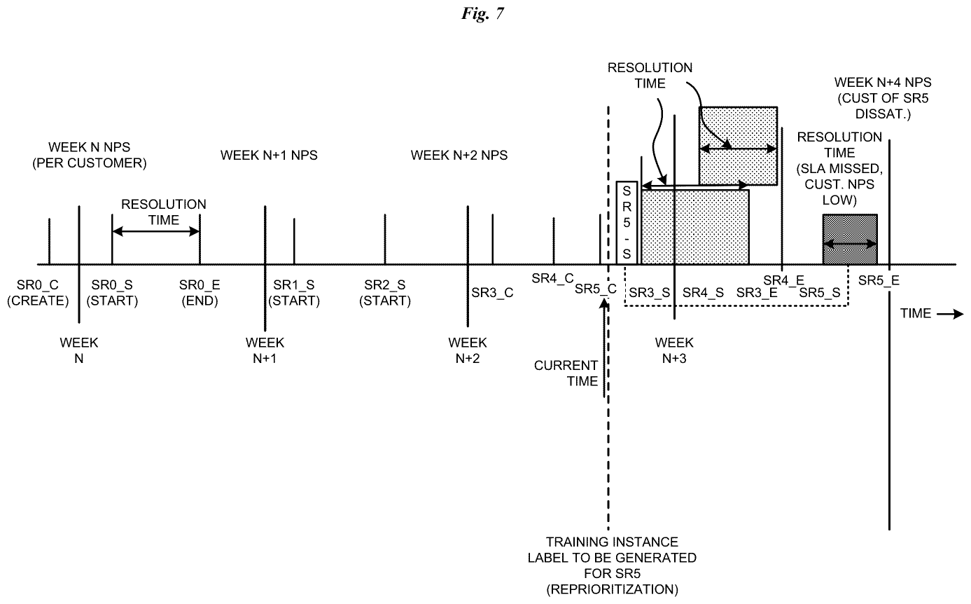

With reference to FIG. 7, this figure depicts a time-domain service request queue reprioritization analysis, in accordance with an illustrative embodiment. In the illustrated embodiment, the following scenario is shown: a historical service request queue including service requests SR1, SR2, SR3, SR4, SR5, each with a corresponding creation time (C), start time(S) and end time (E). As shown in the example scenario, the creation time of SR5 is SR5_C and SR5 is the last service request to be added to the queue. Further, as shown in the example scenario, when the start time for SR5 (SR5_S) is after week N+3, the result is a missed SLA and a low customer NPS score. However, as shown in the example scenario, if the queue is rearranged and SR5_S takes place before week N+3, there is no SLA breach of either SR5, nor of SR1 through SR4. Accordingly, by rearranging the order of the queue so that SR5 begins after SR2 but before SR3, at time 2.5 instead of 5, there are no missed SLAs, indicating a positive training instance generation Further, during the training process, the model is exposed to various scenarios where the rearrangement of the SRs queue leads to successful outcomes without breaching SLAs. By feeding these instances into the deep learning sequencing model and regression model, the system can learn to prioritize service requests effectively based on historical patterns of success. This training approach enables the model to adapt to different client contexts, SLA requirements, and service request characteristics, enhancing its ability to make informed decisions in dynamic triage environments. The utilization of predicted sequences that prevent SLA breaches in training the Triage Decision Support Model ensures that the system is equipped to handle similar scenarios in real-world applications. By learning from historical data where optimal sequencing led to successful outcomes, the model can generalize its decision-making process and apply it to new situations effectively. This training methodology enhances the model's predictive capabilities and empowers it to make informed decisions that prioritize client satisfaction and operational efficiency while mitigating the risk of SLA breaches.

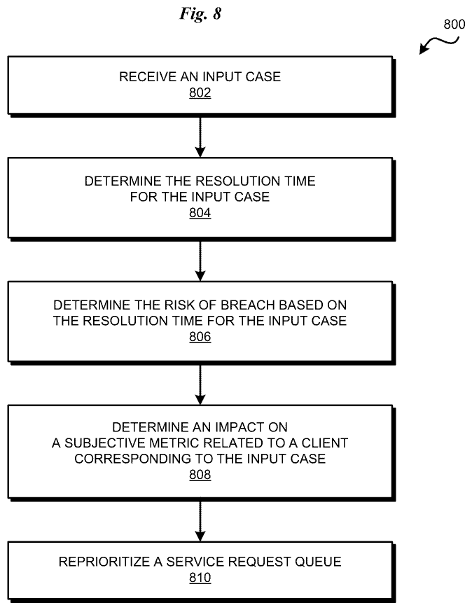

With reference to FIG. 8, this figure depicts a flowchart of an example process of adaptive case handling, in accordance with an illustrative embodiment. In an embodiment, the adaptive case handler 200 of FIGS. 1 and 2 and/or the adaptive case handler module 400 of FIG. 4 carries out the process 700.

At step 802, the process receives a new input case. In some embodiments, the input case includes a service request. In some embodiments, the new input case includes case details, client details, and/or agreement details.

At step 804, the process determines a resolution time for the input case. In some embodiments, the process determines a resolution time for the input case based at least in part on the case details and/or the client details corresponding to the input case. In an embodiment, the process determines a resolution time for the input case via a resolution time prediction model, as described in greater detail herein.

At step 806, the process determines a risk of breach of a service license agreement (SLA) based on resolution time determined for the input case. In an embodiment, the process determines a risk of breach for the input case based at least in part on the determined resolution time via a breach function, as described in greater detail herein.

At step 808, the process determines an impact on a subjective metric related to a client corresponding to the input case. In an embodiment, the process determines the impact on a subjective metric related to a client corresponding to the input case by incorporating client context information into the decision-making process and assessing the potential consequences of different sequencing strategies on the customer satisfaction. By optimizing the sequence of service requests based on both operational efficiency metrics and client-centric metrics, the process ensures a holistic approach to triage decision-making that considers impact to client satisfaction.

In an embodiment, the process derives impact to the subjective metric based on client feedback collected from one or more clients. As a nonlimiting example, the process may include collecting feedback from a client when an SLA breach occurs. Also, the process may include aggregating the feedback from the client when an SLA breach occurs over a period of time to create a set of historical breach impact data. In an embodiment, the process may determine the impact of a potential breach of an SLA based on the historical breach impact data. For example, in an embodiment, the feedback collected may include indicators of customer satisfaction, and the impact may include the effect on customer satisfaction of the client.

At step 810, the process reprioritizes a service request queue to incorporate the input case. In an embodiment, the process reprioritizes the service request queue based at least in part on the predicted resolution time for the input case, the risk of breach corresponding to the input case, and/or the impact on the subjective metric related to the client corresponding to the input case, and also accounting for the potential of SLA breach of the already queued SRs as a result of their reprioritization to incorporate the new service request start time. In an embodiment, the process includes training a Triage Decision Support Model, which may include a sequence model, which computes an optimal vector representation of the queue of unresolved SRs, as well as a regression model, which takes as input the vector representation of the queue of unresolved SRs, and the new SR, to predict when the new SR should be started.

Embodiments of the present disclosure leverage a combination of factors to compute how much to delay start time of service request when there are already pre-existing unresolved service requests in the service request queue. In a resource constrained multi-system environment, determining a sequence of service requests to resolve is traditionally based on severity of case and availability of resources. Embodiments of the present disclosure may consider severity as a factor in determination of a sequence of service requests of a service request queue, as well as may consider various other features, including but not limited to, SLA details, client details, case details, service respondent details, and various other features not currently considered or leveraged into service request queue prioritization and reprioritization.

In an embodiment, the process includes establishing, training, and/or fine tuning one or more deep learning models to uncover relationships between completion (or incompletion) of service requests and impact on subjective client details, such as for example, customer satisfaction. Although customer satisfaction is referenced throughout the present disclosure, it is contemplated that the use of this example is not intended to be limiting aspect of this disclosure. Instead, various other subjective metrics may be extrapolated historical data related to a particular client, region, industry, etc. A “subjective metric” as described herein may include any non-universally shared attribute of an entity that belongs to a group of other entities, including but not limited to, customer satisfaction, likelihood of repeat business, negative caused to reputation, etc.

Currently existing purely algorithmic approaches aimed towards solving a resource constrained multi-project scheduling problem (RCMPSP) fail to incorporate and leverage subjective factors, such as for example, customer satisfaction, in determining an order for completion of service requests and updating an order of service requests of a service request queue upon receiving a new input service request from a client.

A typical service level agreement (SLA) between a service provider and a client may include SLA details that may include, for example, expected resolution time based on severity of case, customer support window times, and various other terms that define a relationship between a client and a service provider. An embodiment of the present disclosure includes establishing an adaptive case handler to automatically reprioritize an existing service request queue upon receiving a new service request. An embodiment of the present disclosure includes optimizing the adaptive case according to selected criteria. In an embodiment, the selected criteria includes minimizing SLA violation penalties. In an embodiment, the selected criteria includes minimizing customer dissatisfaction.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.” References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a service request queue, the service request queue comprising a set of unresolved service requests;
receiving a new service request corresponding to a client;
computing a resolution time for the new service request;
computing a failure risk likelihood based at least in part on the resolution time computed for the new service request;
computing a subjective impact metric corresponding to the client based at least in part on the failure likelihood computed for the new service request; and
updating the service request queue to include the new service request, wherein updating the service request queue comprises reprioritizing the set of unresolved service requests to insert the new service request within a particular location of a sequence of the unresolved service requests.

2. The computer-implemented method of claim 1, wherein the subjective impact metric comprises customer satisfaction.

3. The computer-implemented method of claim 1, wherein the subjective impact metric is derived from historical client feedback data.

4. The computer-implemented method of claim 1, further comprising training a first neural network to uncover a relationship between on-time service request resolution failure and impact on customer satisfaction.

5. The computer-implemented method of claim 1, further comprising delaying a start time for the new service request.

6. The computer-implemented method of claim 1, further comprising delaying a start time for at least one unresolved service request of the service request queue.

7. The computer-implemented method of claim 1, further comprising pausing at least one unresolved service request of the service request queue.

8. The computer-implemented method of claim 1, further comprising:
computing a subjective impact metric corresponding to one or more other clients of the unresolved service request queue;
wherein reprioritizing the set of unresolved service requests considers at least one of the subjective impact metric corresponding to the client and the subjective impact metric corresponding to the one or more other clients.

9. A computer program product comprising one or more computer readable storage media, and program instructions collectively stored on the one or more computer readable storage media, the program instructions executable by a processor to cause the processor to perform operations comprising:
establishing a service request queue, the service request queue comprising a set of unresolved service requests;
receiving a new service request corresponding to a client;
computing a resolution time for the new service request;
computing a failure likelihood based at least in part on the resolution time computed for the new service request;
computing a subjective impact metric corresponding to the client based at least in part on the failure likelihood computed for the new service request; and
updating the service request queue to include the new service request, wherein updating the service request queue comprises reprioritizing the set of unresolved service requests to insert the new service request within a particular location of a sequence of the unresolved service requests.

10. The computer program product of claim 9, wherein the program instructions are stored in a computer readable storage device in a data processing system, and wherein the stored program instructions are transferred over a network from a remote data processing system.

11. The computer program product of claim 9, wherein the program instructions are stored in a computer readable storage device in a server data processing system, and wherein the program instructions are downloaded in response to a request over a network to a remote data processing system for use in the computer readable storage device associated with the remote data processing system, further comprising:
program instructions to meter use of the program instructions associated with the request; and
program instructions to generate an invoice based on the metered use.

12. The computer program product of claim 9, wherein the operations further comprise training a first neural network to uncover a relationship between on-time service request resolution failure and impact on customer satisfaction.

13. The computer program product of claim 9, wherein the operations further comprise delaying a start time for the new input service request.

14. The computer program product of claim 9, wherein the operations further comprise further delaying a start time for at least one unresolved service request of the service request queue.

15. A computer system comprising a processor and one or more computer readable storage media, and program instructions collectively stored on the one or more computer readable storage media, the program instructions executable by the processor to cause the processor to perform operations comprising:
establishing a service request queue, the service request queue comprising a set of unresolved service requests;
receiving a new service request corresponding to a client;
computing a resolution time for the new service request;
computing a failure likelihood based at least in part on the resolution time computed for the new service request;
computing a subjective impact metric corresponding to the client based at least in part on the failure likelihood computed for the new service request; and
updating the service request queue to include the new service request, wherein updating the service request queue comprises reprioritizing the set of unresolved service requests to insert the new service request within a particular location of a sequence of the unresolved service requests.

16. The computer system of claim 15, wherein the subjective impact metric comprises customer satisfaction.

17. The computer system of claim 15, wherein the subjective impact metric is derived from historical client feedback data.

18. The computer system of claim 15, wherein the operations further comprise training a first neural network to uncover a relationship between on-time service request resolution failure and impact on customer satisfaction.

19. The computer system of claim 15, wherein the operations further comprise delaying a start time for the new service request.

20. The computer system of claim 15, wherein the operations further comprise delaying a start time for at least one unresolved service request of the service request queue.
